(19) United States
(12) Patent Application Publication
(10) Pub. No.: US 2011/0181127 A1
(43) Pub. Date: Jul. 28, 2011

(54) MEDIUM VOLTAGE ELECTRIC ROTARY JOINT FOR A WIND TURBINE GENERATOR

(75) Inventor: Mojtaba SAFABAKHSH, Yardley, PA (US)

(73) Assignee: GAMESA INNOVATION & TECHNOLOGY, S.L.,

(21) Appl. No.: 13/013,246

(22) Filed: Jan. 25, 2011

(30) Foreign Application Priority Data
Jan. 26, 2010 (ES) 201000088

(51) Int. Cl. H01R 39/08

(52) U.S. Cl. 307/145

(57) ABSTRACT

Medium voltage electric rotary joint for energy conduction between the rotating nacelle 1 and the static tower 2 of a wind turbine generator comprising a pivoted and ball-bearing mounted 5 upper housing 6 and a fixed lower housing 7; mounted coaxially on a centre shaft 8; brushes 9 and springs 10 located within an insulator epoxy 11 inside the upper housing 6 and equivalent copper rings 12 located within an insulator epoxy 11 inside the lower housing 7; cable connector plugs 13 attached to mountable insulated bushings 14, a protective booth 15, seals 16 and upper and lower cable supports 17,18.

### TECHNICAL FIELD OF THE INVENTION

This invention relates to a wind turbine generator and in particular to a medium voltage electric rotary joint for electrical energy conduction between the rotating nacelle and the static tower of a wind turbine generator.

### BACKGROUND ART

Wind turbines are devices that convert mechanical energy to electrical energy. A typical wind turbine includes a rotating nacelle mounted on a static tower housing, a drive train for transmitting the rotation of a wind rotor to an electric generator and other components such as a yaw drive which rotates the wind turbine nacelle, several controllers and a brake. The wind turbine rotor is comprised of a rotating hub supporting a number of blades extending radially for capturing the kinetic energy of the wind and causing the drive train rotational motion. The rotor blades have an aerodynamic shape such that, when wind blows across the surface of the blades, a lift force is generated causing the rotation of a shaft which is connected, directly or through a gearing arrangement, to the electricity generator.

Traditionally, the conduction of the generated electrical energy from the rotating nacelle to the bottom of the static tower of a wind turbine generator is realized by the usage of one or more medium voltage cables in various diameters, lengths and variants installed in the inside of the tower.

The type of cable used is usually selected with reference to technical parameters for the specific type of wind turbine generator, like the height of the wind turbine generator tower, the specifications of power which needs to be conducted from the generator to the grid and other requirements e.g. special environmental conditions, codes and standards.

Furthermore, due to the rotation and continuous re-orientation of the nacelle in the optimal direction of the wind, the cable length is usually designed longer than necessary (where necessary means roughly the direct distance between the top and bottom of the tower) to achieve a certain number of complete nacelle rotations until the power cables are under complete tension. This design is basically used to provide some extra cable length for the wiring and twisting of the cables as a consequence of the turning and rotating nacelle of the wind turbine generator. Problems of this solution are well known, e.g. the back rotating behaviour of the nacelle for unwinding the power cables when they are completely under tension, the significant heavier weight of the longer than necessary measured cables and of course the economical disadvantages, like the time-loss for the nacelle's back rotating as well as the higher production or investment costs for extra materials and more cables.

Regarding this technical field and background, the State-Of-The-Art offers different solutions for this problem.

In one of these (WO 2009/061209 A1) a combined electric and hydraulic swivel is disclosed. The main idea of this application is a rearrangement of the electric generator on the bottom of the tower for reducing the weight of the nacelle. To accomplish this, a hybrid electric/hydraulic swivel is used for transmitting control and measurement signals and as well as the kinetic energy of the rotor from the top to the bottom of the wind turbine generator arrangement. Besides general difference of the main idea—the relocation of the generator to the bottom level of the tower—this solution comprises some technical disadvantages like the losses of energy conversion due to frictions of fluids in boundary conditions as well as the compressibility of fluids.

The present invention is intended to solve this problem.

### SHORT SUMMARY OF THE INVENTION

It is an object of the present invention to provide a medium voltage electric rotary joint between the nacelle and tower top section of a wind turbine generator, which avoids the introduced winding and twisting problem of the traditional cable layout as today.

The medium voltage cable running from the nacelle to the tower has to be able to rotate with the nacelle while the tower is fixed. Historically, some length of cable and a combination of geometries are foreseen to allow the cable to flex in torsion and some linear displacements to prevent it from mechanical overstrain.

Also the yawing function has been controlled to ensure that the nacelle rotates only so far and returns back to a “home position”. Currently, there are some investments in reduced life of cable due to the mechanical loads and the real estate used to provide for cable feed, and the control scheme on yawing.

This medium voltage electric rotary joint will allow the top and bottom cables to be fixed and establish connection through the rotating member on top. More specifically the medium voltage electric rotary joint enables an electrical power transmission of rotating electrical machines and generators at a conductive joint between the moving upper power cable of the rotating nacelle and the fixed lower power cable of the static tower of a wind turbine,

To achieve this, the rotary joint comprises of an axially rotating upper housing and a fixed lower housing mounted coaxially on a centre shaft, at least one cable connector plug connected to a corresponding mountable insulated bushing mounted to the upper and lower housing and at least one brush and at least one spring located inside an insulator within the rotary upper housing and at least one ring located inside an insulator within the fixed lower housing.

Due to this simple, but reliable design this conductive medium voltage electric rotary joint is also easy addable to existing wind turbine generators as a retrofit or upgrade as well as to new developed and constructed wind turbine generators.

### BRIEF DESCRIPTION OF DRAWINGS

FIG. 1 is total schematic side view of a common wind turbine generator.

FIG. 2 is a schematic top view of common wind turbine generator.

FIG. 3 is a schematic section side view of the medium voltage electric rotary joint according to the invention.

FIG. 4 is a schematic top view of the electrical joint including the mountable bushings arrangement.

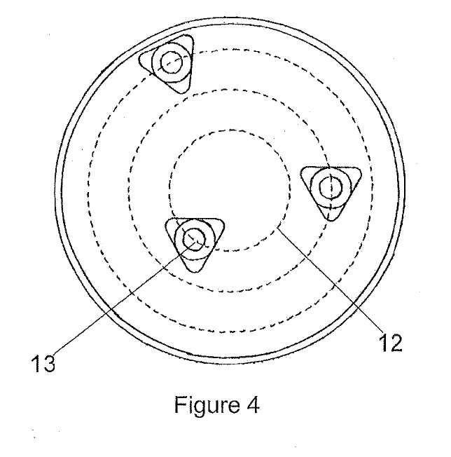

### EMBODIMENTS OF THE INVENTION

This invention will in the following be described referring to the attached figures and will describe a number of embodiments to the invention. It should be noted that, the invention should not be limited to the embodiments described in this disclosure, and than any embodiments lying within the spirit of this invention should be considered part of the disclosure.

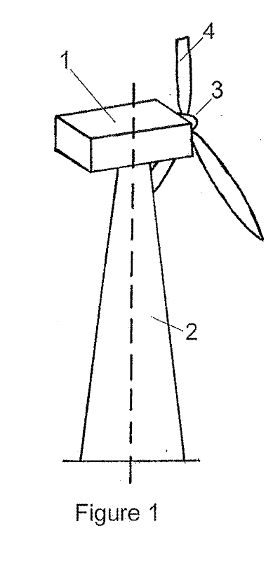

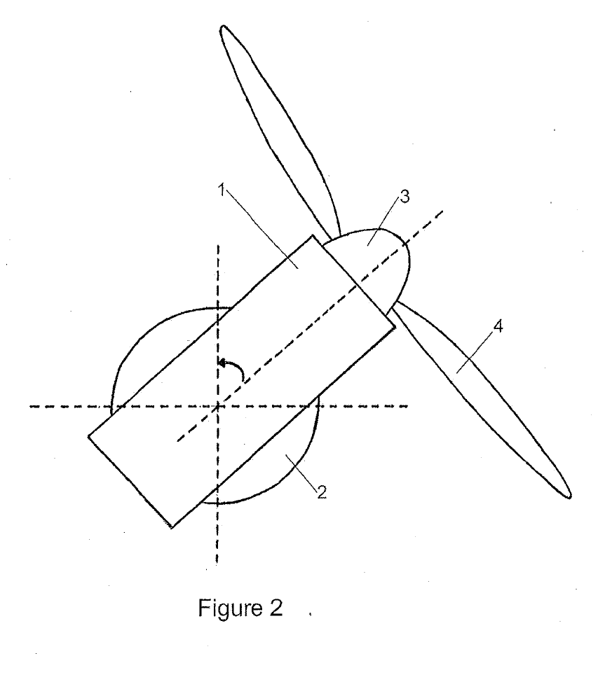

Wind turbines are devices that convert mechanical energy to electrical energy. A wind turbine as represented in FIGS. 1 and 2 includes a rotating nacelle (1) mounted on a static tower (2) housing, a drive train for transmitting the rotation of a wind rotor to an electric generator and other components such as a yaw drive which rotates the wind turbine nacelle, several controllers and a brake. The wind rotor is comprised of a rotor hub (3) supporting a number of blades (4) extending radially there from for capturing the kinetic energy of the wind and causing the driving train rotational motion. The rotor blades (4) have an aerodynamic shape such that when wind blows across the surface of the blades, a lift force is generated causing the rotation of a shaft which is connected—directly or through a gearing arrangement—to the electrical generator.

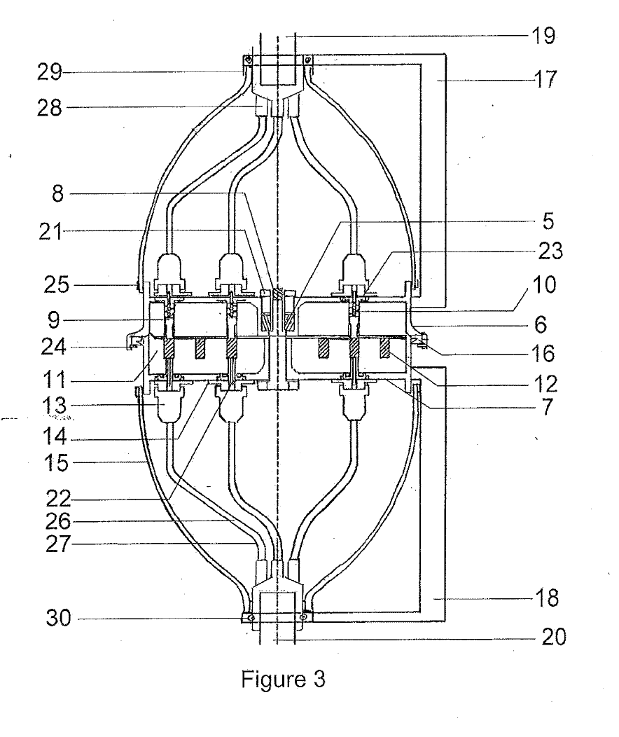

The present invention refers to a medium voltage electric rotary joint located between the nacelle (1) and tower (2) top section to achieve rotary motion between the rotating upper power cable (19) and the fixed lower power cable (20)—see FIG. 3—comprising, at least six cable connector plugs (13) connected to the corresponding mountable insulated bushings (14) mounted to an upper (6) and lower (7) housing. The upper (6) and lower housing (7) are coaxially aligned and connected by the center shaft (8). The upper housing (6) is due to a tapered roller bearing (5) dynamically rotatable by its longitudinal axis, while the lower housing (7) is fixed to the center shaft (8). A nut (21) secures the upper (6) and lower (7) housing from slipping off the center shaft (8).

The lower housing (7) comprises three rings (12), preferably copper rings, positioned concentrically. The copper rings (12) are located inside an insulator (11), preferably epoxy in the form of an encapsulating resin. The power conduction within the lower housing (7) starts from the copper rings (12) and runs through the directly connected braided wires (22), the mountable insulated bushings (14), the cable connector plugs (13) and ends into a single cable with a braided wire (26).

The upper housing (6) comprises three brushes (9) for interconnecting the cable connectors (13) and energy conduction to the copper rings (12) inside the lower housing (7). Springs (10) will be used to press the brushes (9) continuously against the copper conducting rings (12). The brushes (9) as well as the springs (10) pulling down the brushes (9) are by an insulated brush spring holder (23) arrested. The power conduction within the upper housing (6) starts from the brushes (9) and runs through the directly connected braided wires (22), the mountable insulated bushings (14), the cable connector plugs (13) and ends into a single cable with a braided wire (26).

At the point of contact between the upper (6) and lower housing (7), a lip seal (16) for dust and moisture prevention for protecting the brushes (9) and copper rings (12) is used. The lip seal (16) is fixed and maintained in position by a retaining Circlip (24). The upper (6) and lower (7) housing are with a housing side booth clamp (25) attached and fixed to the protection booth (15).

The single cables with braided wires (26) are coated with heat shrink and stress controlled wall tubes (27) and join into a pant booth (28), in this case a three-leg pant booth. To avoid torsion forces on the single cables (26) and to achieve geometric stability and force conduction for supporting the medium voltage electric rotary joint the upper (17) and lower tripod cable supports (18) are used. These tripod cables supports (17, 18) can be easily connected by appropriate connecting arms to the tower (2) and nacelle (1) of the wind turbine generator. From the upper (6) and lower (7) housing a protection booth (15) covers the whole device. The protection booth (15) can be installed on the cables and strapped at the cable clamp (30) and around the contact points of the housings (6,7)—both at the top and bottom—to protect the cables (26) and connectors (13) from impact, dust and moisture. The protection booth (15) is fixed by the cable side booth clamp (29).

1. Medium voltage electric rotary joint for a wind turbine generator to enable an electrical power transmission of rotating electrical machines and generators at a conductive joint between the moving upper power cable (19) of the rotating nacelle (1) and the fixed lower power cable (20) of the static tower (2) of the WTG,
characterized in that the rotary joint comprises
an axial-bearing (5), rotary upper housing (6) and a fixed lower housing (7) mounted coaxially on a centre shaft (8);
at least one brush (9) and at least one spring (10) located inside an insulator (11) within the rotary upper housing (6) and at least one ring (12) located inside an insulator (11) within the fixed lower housing (7);
at least one cable connector plug (13) attached to at least one mountable insulated bushing (14);
and at least one cable support frame (17,18).

2. Medium voltage electrical rotary joint according to claim 1, wherein at least one protective booth (15) encases the at least one mountable insulated bushing (14), the at least one cable connector plug (13) and at least a single cable with braided wires (26) and the centre shaft (8).

3. Medium voltage electrical rotary joint according to claim 2, wherein an encasing protective booth (15) is connected to the moving upper power cable (19) by a cable side booth clamp (29) and to the rotating upper housing (6) by a housing side booth clamp (25).

4. Medium voltage electrical rotary joint according to claim 2, wherein the at least one encasing protective booth (15) is connected to the lower fixed power cable (20) by a cable side booth clamp (29) and to the fixed lower housing (7) by a housing side booth clamp (25).

5. Medium voltage electrical rotary joint according to claim 1, wherein at least one radial seal (16) is located at the outer diameter contact point of the upper (6) and lower (7) housing.

6. Medium voltage electrical rotary joint according to claim 5, wherein the radial seal (16) is fixed and held in position by a circumferential retaining Circlip (24).

7. Medium voltage electrical rotary joint according to claim 1, wherein at least one upper tripod (17) cable support frame is connected to the moving upper power cable (19) and at least one lower tripod cable support frame (18) is connected to the fixed lower power cable (20).

8. Medium voltage electrical rotary joint according to claim 7, wherein the upper tripod cable support frame (17) is connected by a cable clamp (30) to the upper power moving cable (19).

9. Medium voltage electrical rotary joint according to claim 7, wherein the lower tripod cable support frame (18) is connected by a cable clamp (30) to the lower fixed power cable (20).

10. Medium voltage electrical rotary joint according to claim 1, wherein the at least one spring (10) pushing down at least one brush (9), is located in the rotating upper housing (6), encapsulated by the insulator (11) and held in tension by an insulated brush spring holder (23).

11. Medium voltage electrical rotary joint according to claim 1, wherein at least one ring (12) located in the fixed lower housing (7) and encapsulated by the insulator (11) is conductively connected to a braided wire (22) from the lower static power cable (20).

12. Medium voltage electrical rotary joint according to claim 1, wherein the axial bearing (5) is preferably equipped with a tapered roller bearing.

13. Medium voltage electrical rotary joint according to claim 1, wherein the insulator (11) material is preferably epoxy in the form of an encapsulating resin.

14. Medium voltage electrical rotary joint according to claim 1, wherein at least one ring (12) is preferably a copper ring.
